(19) United States
(12) Patent Application Publication
(10) Pub. No.: US 2018/0068583 A1
(43) Pub. Date: Mar. 8, 2018

(54) Physical Therapy Device and Spinning Toy

(71) Applicants: ElSayed Ibrahim Ouda, Bolingbrook, IL (US); Karilyn Ann Ouda, Bolingbrook, IL (US)

(72) Inventors: ElSayed Ibrahim Ouda, Bolingbrook, IL (US); Karilyn Ann Ouda, Bolingbrook, IL (US)

(73) Assignees: ElSayed Ibrahim Ouda, Bolingbrook, IL (US); Karilyn Ann Ouda, Bolingbrook, IL (US)

(21) Appl. No.: 15/257,559

(22) Filed: Sep. 6, 2016

(51) Int. Cl. G09B 19/00; G09B 5/00; A63H 1/24

(52) U.S. Cl. CPC G09B 19/003; A63H 1/24; G09B 5/00

(57) ABSTRACT

A spinning device, comprising: (a) a base portion comprising: a base face; a side face; and a top face; a substantially ring-shaped groove extending upwardly from the base face, and a spinning edge portion between the side face and the base face; and (b) a top portion connected to the top face of the base portion, the device having a mass distribution balancing the device on the spinning edge portion while the device is spinning.

### BACKGROUND

Strokes, accidents and other medical conditions can cause a person to lose the ability to control fine motor actions. Up to 85% of stroke patients have an initial arm sensorimotor dysfunction with impairments persisting for more than 3 months. While many rehabilitation methods have been developed, for various reasons patients do not keep to the methods and/or for other reasons do not reassume a reasonable level of control.

Traumatic injury to the wrist can also create a need for rehabilitative therapy. The human wrist is a relatively complex structure, and damage to the wrist can result in injuries which are difficult and time consuming to heal. Traditionally, the injured wrist is immobilized to permit the joining of broken bones and torn tendons, as well as to allow the healing of inflamed tendons. After the structure has healed, it can be difficult to develop full muscular strength and flexibility in the wrist, as the muscles and tendons tend to atrophy to a certain degree due to the immobilization. Accordingly, therapists have long been aware of the need to exercise the wrist, gradually building up the strength and mobility of the joint until optimum strength and mobility have been reached. Such therapy is quite costly due to the specialized equipment often used, as well as the cost of usually personalized therapy provided by a specialist.

### SUMMARY

In one aspect, the invention provides a spinning device, comprising: (a) a base portion comprising: a base face; a side face; and a top face; a substantially ring-shaped groove extending upwardly from the base face, and a spinning edge portion between the side face and the base face; and (b) a top portion connected to the top face of the base portion, the device having a mass distribution balancing the device on the spinning edge portion while the device is spinning.

In a second aspect the invention provides a method of training motor skills, comprising spinning a spinning device, the spinning device comprising: (a) a base portion comprising: a base face; a side face; and a top face; a substantially ring-shaped groove extending upwardly from the base face, and a spinning edge portion between the side face and the base face; and (b) a top portion connected to the top face of the base portion, the device having a mass distribution balancing the device on the spinning edge portion while the device is spinning.

In a third aspect, the invention provides a spinning device, comprising: (a) a base portion comprising: a base face; a side face; and a top face; a substantially ring-shaped groove extending upwardly from the base face, and a spinning edge portion between the side face and the base face; and (b) a top portion connected to the top face of the base portion, the device having a mass distribution evenly distributed around at least one axis passing through the spinning edge portion and the center of mass of the device.

The scope of the present invention is defined solely by the appended claims and is not affected by the statements within this summary.

The following definitions are included to provide a clear and consistent understanding of the specification and claims.

The term program and/or the phrase computer program are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system).

The term “approximately” is intended to mean at least within 10% of a given value.

The term “substantially” is intended to mean largely but not necessarily wholly that which is specified.

The term “substantially circular” as used herein means that an item has a morphology that includes circular, as well as oblong, and the like and can have irregularities. The circularity of a given item may be determined using image analyzer programmed to identify and measure an image of the item in the form of a circle, and calculating the circularity of the item according to one or more of the algorithms known in the art. In one such algorithm, the circularity of an item is calculated as Da/Dp (where Da=(4A/π); Dp=(P/π)²; A=pixel area; P=pixel perimeter), which is a value from zero to one, with one representing a circle. Unless specifically stated, the item can have a circularity calculated according to such algorithm which is equal to 0.95 or more.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1A is a perspective view of an example spinning device where the base face of the device is shown. FIG. 1B is another perspective view of the example spinning device of FIG. 1A where the top face of the device is shown.

FIG. 2A is a side view of the example spinning device as shown in FIG. 1. FIG. 2B is a side magnified side view of the rim of the device as shown in FIG. 1. FIG. 2C is a side view of another example spinning device. FIG. 2D is a side view of yet another example spinning device.

FIG. 3A is a cross-sectional view of an example spinning device. FIG. 3B is a cross-sectional view of another example spinning device.

FIG. 4A is a side view of an example spinning device featuring a top face that is flat. FIG. 4B is a side view of an example spinning device where the top face is curved in shape. FIG. 4C is a side view of an example spinning device where the top face and the side face are merged.

FIG. 5A is a side view of an example spinning device illustrating the center of mass of the device. FIG. 5B is a top view of the device as shown in FIG. 1. FIG. 5C is a bottom view of the device as shown in FIG. 1.

FIGS. 6A, 6B, and 6C illustrate a preferred method of operating an example spinning device.

### DETAILED DESCRIPTION

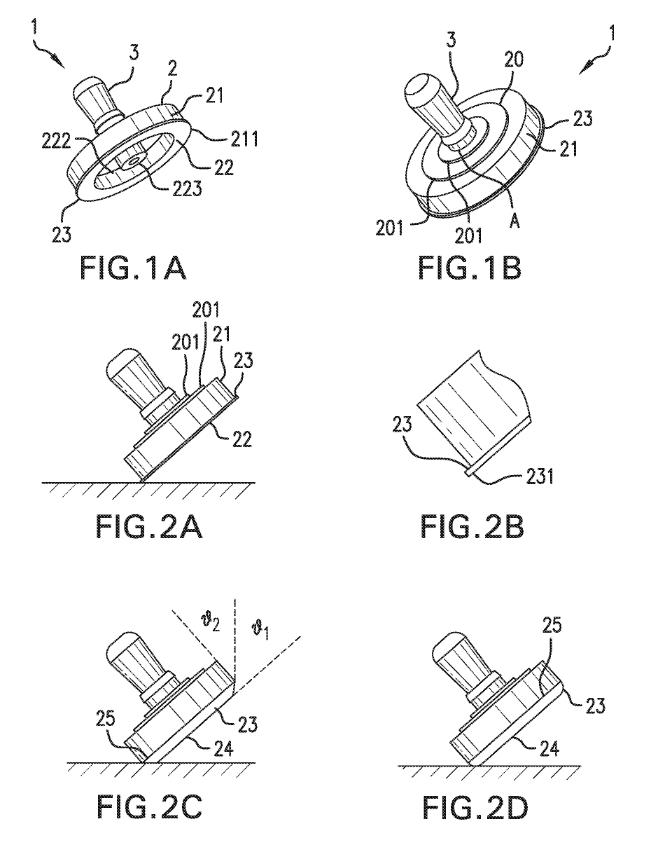

Referring to FIGS. 1A and 1B, an example spinning device 1 according to one aspect of the invention is shown. Device 1 includes base portion 2 and a top portion 3. The base portion 2 features a top face 20, a side face 21, and a base face 22. The top portion 3 is attached to the top face 20. Preferably, top portion 3 is elongated in shape, of a substantially smaller diameter than base portion 2, and projecting centrally from top face 20 in a perpendicular direction relative to top face 20. More preferably, the top portion 3 is elongated in shape and slightly tapering downwards. Optionally, the end of top portion 3 that is distal to base portion 2 may be provided with ridges, projections or ribs for ease of gripping by a user.

Preferably, side face 21 has a perimeter that is polygonal in shape, such as a square, pentagon, hexagon, heptagon, octagon, nonagon, decagon, hendecagon, or dodecagon with or without rounded edges and with or without rounded corners. More preferably, side face 21 has a perimeter that is substantially circular in shape. A spinning edge portion 23 is located on the perimeter between side face 21 and base face 22. Preferably, spinning edge portion 23 is polygonal in shape, such as a square, pentagon, hexagon, heptagon, octagon, nonagon, decagon, hendecagon, or dodecagon with or without rounded edges and with or without rounded corners. More preferably, spinning edge portion 23 is substantially circular in shape. Preferably, spinning edge portion 23 intersects a diameter of the device in at least two points, where the diameter of the device is herein defined as the longest axis between two points of the base portion.

As illustrated in the example embodiment of FIG. 2A, the spinning edge portion 23 may be in the form of a rim projecting outwardly from the edge where the base face 22 meets the side face 21. As illustrated in FIG. 2B, the bottom surface 231 of the rim is preferably flat.

FIG. 2C illustrates another example embodiment where spinning edge portion 23 is provided in the form of a strip interposed between outer perimeter 24 of the base face 22 and bottom perimeter 25 of side face 21. The width of such strip is preferably of at least 0.1 mm and at most 10 mm, more preferably of at least 0.3 mm and at most 3 mm, and most preferably of at least 0.5 mm and at most 2 mm. The strip forms a first angle theta₁ with base face 22 and a second angle theta₂ with side face 21. Preferably, angle theta₁ is at most 90 degrees and angle theta₂ is at most 90 degrees. More preferably, angle theta₁ is at most 60 degrees and at least 30 degrees and angle theta₂ is at most 60 degrees and at least 30 degrees. Most preferably, angle theta₂ is at most 50 degrees and at least 40 degrees and angle theta₂ is at most 50 degrees and at least 40 degrees.

In the example embodiment of FIG. 2D, spinning edge portion 23 is provided in the form of a strip which forms a curve between outer perimeter 24 of base face 22 and bottom perimeter 25 of side face 21.

The size arid proportions of the device may vary to suit the needs of different users. Preferably, the height of the device is at least 6 cm to at most 18 cm, more preferably at least 9 cm to at most 15 cm, and most preferably at least 11 cm to at most 12 cm. The diameter of the device is also at least 6 cm to at most 18 cm, more preferably at least 9 cm to at most 15 cm, and most preferably at least 11 cm to at most 12 cm. In preferred embodiments, the height and diameter of the device are approximately the same, for instance in a spinning device having a height of 11.4 cm and a diameter of 11.4 cm.

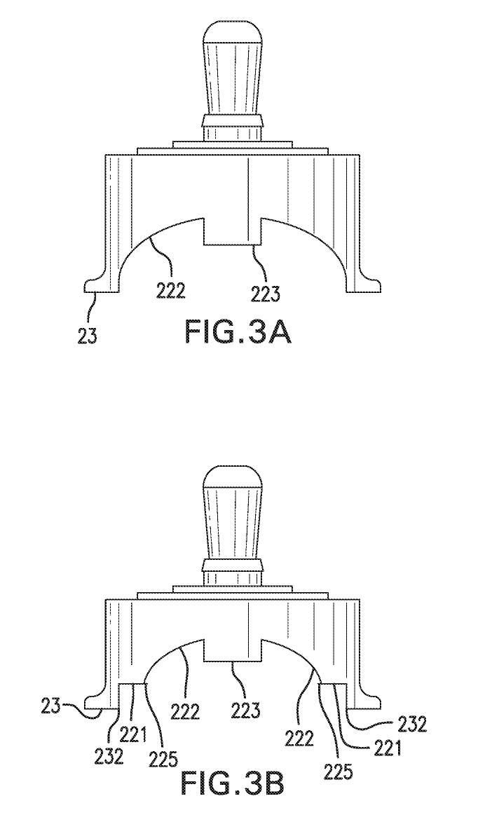

The base face 22 may be solid, but in preferred embodiments a substantially ring-shaped groove 222 is formed in the base face 22, as illustrated in FIG. 3A. The substantially ring-shaped groove 222 defines a protrusion 223. The protrusion 223 preferably has a substantially circular cross-section, but other cross-sectional shapes, such as square or equilateral triangular, are also contemplated. Preferably, the substantially ring-shaped groove 222 entirely encompasses the protrusion 223. The surface of the substantially ring-shaped groove 222 preferably curves downwardly to form a vault, but embodiments are also contemplated where such surface is defined by side walls and a ceiling. For example, such side walls and ceiling may form right angles with each other.

Embodiments are contemplated where the substantially ring-shaped groove 222 extends from the protrusion 223 all the way to the spinning edge portion 23. In other embodiments, such as that of FIG. 3B, a bottom inner surface 221 is interposed between the inner perimeter 232 of spinning edge portion 23 and the outer perimeter 225 of ring-shaped groove 222. Preferably, the bottom inner surface 221 is substantially flat. Alternatively, an inner section of bottom inner surface 221 may be substantially flat while an outer section is at an angle with the inner perimeter 232 of spinning edge portion 23.

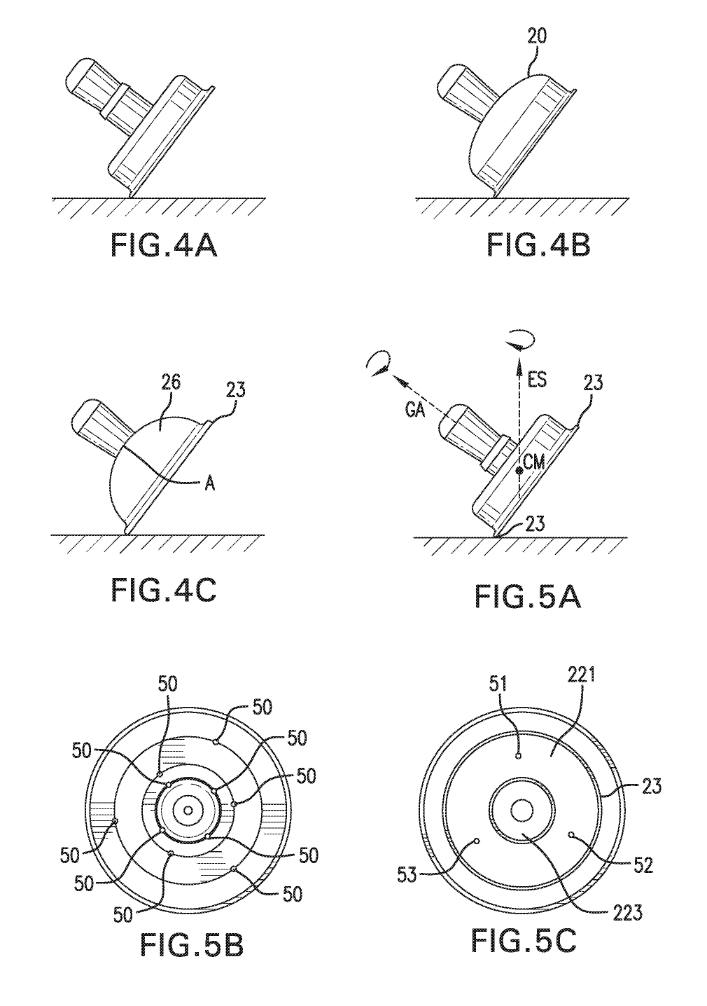

Top face 20 may have concentric ridges 201, as seen in FIGS. 1-3, but other geometries are also contemplated. FIG. 4A illustrates a device where top face 20 is flat. FIG. 4B illustrates a device where top face 20 is curved in shape, forming a dome-like surface. Also, as illustrated in FIG. 4C, the top face and the side face may be merged to form a straight or curved surface 26 that extends from the location A where the top 3 is attached to the top face 20 down to edge portion 23.

The distribution of mass within a spinning device according to this aspect of the invention is such that the device can be spun on a surface, the resulting spinning motion of which causes it to be balanced on the spinning edge portion. In a particularly preferred embodiment, this is achieved by evenly distributing the mass of the device around axes which pass through the spinning edge portion and the device center of mass CM, such as example axis ES (FIG. 5A). As a result, the device spins in a uniform manner around such axes, thereby enabling the device to balance on the spinning edge portion while spinning. This type of rotation on the spinning edge portion is hereinafter referred to as “edge spinning”.

Thus, the mass distribution of the spinning device may be tailored in a fashion that will minimize torque exerted by gravity while the device is spinning about the spinning edge axes. Preferably, the ratio W_{B}:W_{T}, where W_{B} is the weight of the base portion 2 and W_{T} is the weight of the top portion 3, is equal to at least 1:4 to at most 4:1. More preferably, the ratio W_{B}:W_{T} is equal to at least 1:3 to at least 3:1. Yet more preferably, the ratio W_{B}:W_{T} is equal to at least 1.5:1 to at most 2.5:1. Most preferably, the ratio W_{B}:W_{T} is equal to about 2:1.

If the option of changing the mass distribution of the device is desired, one or more adjustable weights and/or movable weights may be provided with or fitted to the device. Then, a user may modify the dynamical properties of the device by attaching such weights to the device, changing their position, or both. Thus, modifications such as a change in the position of the center of mass of the device may be achieved.

Optionally, the device may be fitted with one or more light-emitting elements such as light-emitting diodes (LEDs) of desired shape, size, power output, and color. Referring to FIG. 5B, where the example device of FIG. 1 is viewed from the top, locations where spaced apart light-emitting elements 50 may be disposed include the surface of the top face 20 and the surface of side face 21. Turning now to FIG. 5C, where a bottom view of the device of FIG. 1 is provided, light-emitting elements may also be disposed on the base face 22, as exemplified by light-emitting elements 51, 52, and 53 on the walls of circular-shaped groove 222. Each light-emitting element may be configured to emit light at one or more wavelengths, and light emitted by two or more elements may be combined by virtue of the motion of the spinning device to produce pleasing visual effects. For example, element 51 may emit red light, element 52 green light, and element 53 blue light, and the spinning motion of the device may combine the light from all three element to create white light in the eyes of a user. In a fashion similar to that described for a time marking chronometer, the light-emitting elements may be under control of the user or be activated and deactivated by means of an automatic mechanism.

A power supply may be fitted to the device and electrically connected to features that require electrical power such as timers, light-emitting elements, and other items of electric circuitry. In one embodiment, the power supply is disposed inside the protrusion 223. Alternatively, the power supply may be disposed inside the finger grip body 3. As long as the weight distribution and balance of the entire device 1 is substantially maintained, any suitable disposition of the power supply is acceptable. The power supply may be a lithium battery, an alkaline battery, or a carbon-zinc cell. When the power supply is located on the surface of the device 1, the power supply may be configured as a solar power.

In some embodiments, the device is fitted with electrical circuitry connected to a timer, such as a time marking chronometer and an optional display. Example electrical circuitry includes a processor connected to the chronometer, a display and a user interface. The processor may also be connected to a memory storage medium. The memory storage medium may be a magnetic, optical, or semiconductor memory, another processor readable storage device, or the like. The storage medium may be a fixed memory device or a removable memory device, such as a memory card. The electrical circuitry may have other components and configurations, for instance a spin counter instead of or in addition to the timer.

The user interface has contacts that connect or electrically communicate with the processor. Electrically communicate includes through wires, wirelessly, and the like. The user interface transmits input by the user to the processor. Output signals from the processor may be presented on a display, light-emitting elements, or a microphone. The display may be analog or digital. The Display may be a LCD, a LED, an OLED, a vacuum fluorescent, or other display adapted to show an alphanumerical reading. Other types of display may be used. The display electrically communicates with the processor. The display may be separate from the spinning device, such as when in wireless communication with the processor. Alternatively, the display may be removed from the device, such as when the device wirelessly communicates with a remote computing device.

The processor implements the management of the timer, light-emitting elements, and other electric circuitry items associated with the spinning device using processor readable programs and data stored in the storage medium. In one embodiment, the processor starts the timer in response to a user input or when a sensor determines that device has been set spinning by the user. The processor then directs the timer to stop and provide a spinning time reading when the device comes to rest. The time reading may be output to the display and may be stored in the storage medium. The processor may compare the time reading to one or more readings obtained previously or subsequent in time, such as spin times obtained by other users. Alternatively, or in combination with the above timer, the device may also be equipped with a spin counter for counting the number of spinning revolutions achieved by a user in a given spin time or before the device comes to rest. The processor may then output readings from the timer and/or the spin counter to the display and store them in the storage medium, thereby enabling a comparison with readings obtained in previous spins by the same or other users.

The storage medium may be a magnetic, optical, or semiconductor memory, another processor readable storage device, or the like. The storage medium may be a fixed memory device or a removable memory device, such as a memory card.

Operation

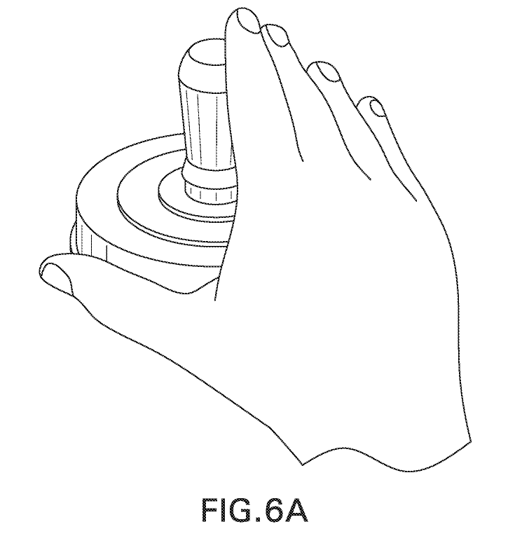

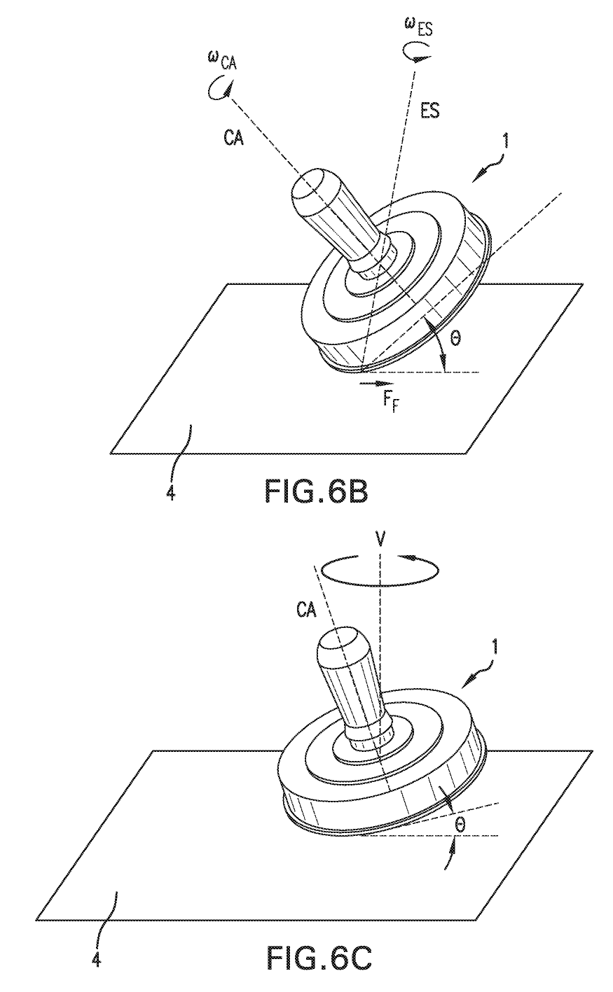

FIGS. 6A-6C illustrates a preferred method of operating an example device according to the present application. The user begins by holding the device 1 as shown in FIG. 6A, with the thumb placed on the base portion 2 and one or more fingers on the top portion 3, and then sets the device 1 in motion. The user may also hold the device 1 in a different way, or with two hands. The single or double hand spin will present new challenges and will indeed encourage or stimulate still new timing and coordination skills.

The device is then released, allowing it to initiate an edge spinning motion on a surface, for instance a smooth surface 4 such as a floor or a table top. As illustrated in FIG. 6B, such edge spinning motion may be characterized as being associated with an edge spinning angular velocity omega_{ES} (“ωₑₛ”) about axis ES. Also as illustrated in FIG. 6B, friction force F_{f} between the surface 4 and the spinning edge portion 23 produces a torque along central axis CA, thereby giving rise to a rotation about axis CA which may in turn be characterized as being associated with an angular velocity about the central axis omega_{CA} (“ω_{ca}”).

The device will spin at an angle to the surface theta (“θ”) of preferably about 45 degrees in a stable manner until the edge spinning angular velocity ωₑₛ diminishes due to friction losses such as aerodynamic drag. This slowdown leads to a gradual drop in height of the center of mass CM of the device, which causes the angle θ to get smaller and smaller as a result. This in turn causes central axis CA to precess at smaller and smaller radiuses about the vertical direction V (FIG. 6C). This process continues until the angle θ becomes so small that friction with the surface 4 increases to the point that the device is brought to a halt. Without wishing to be bound by any particular theory, it is believed that, while the device is spinning, groove 222 traps air between it and the surface 4 and the base face 22, thereby prolonging the spinning time of the device. The spinning hinders the ability of the air to escape, thereby increasing the overall spinning time.

As the device spins and the light-emitting elements emit light, visual effects including circles of light that move intermittently can be achieved. The device can be started spinning at differing angles to the surface, and can changes such angle as it speeds up and slows down during the spinning action. Each spin may differ from other spins in the number of cycles/revolutions, length of spin, device movement and light movements throughout the spin.

According to one aspect of the present invention, a spinning device as disclosed in the present application can be used in as an educational or re-educational tool, for example in post-operative, post-traumatic neuromuscular coordination training and retraining. Unlike many traditional training methods, the spinning device provides for fun and engaging exercises for the fingers, wrist, forearm, upper arm and shoulder of a patient. Thus, methods of rehabilitation are provided where patient compliance and motivation is easier to obtain, which in turn can lead to better therapeutic results and achieve acceptable levels of motor function recovery.

In one such method, a patient in need of rehabilitative therapy in the wrist W can practice wrist dorsiflexion along the wrist axis WA by setting the device spinning in the manner described above. Equipping the device with means for measuring spinning times and speeds achieved by the patient, such as a time chronometer, allows patients and their caregivers to keep track of improvements as the rehabilitation therapy progresses. The method may further include having the device programmed to output visual and auditory stimuli to improve the patient's mood, and to further encourage the patient with rehabilitative exercising schedules.

The device also finds applications outside the field of patient motor rehabilitation, for example as an educational toy for the teaching of the principles of aerodynamics, gravity, light combination and as a tool for exercising and improving motor skills of healthy subjects in a fun setting. Thus, in another aspect, a method is provided whereby a plurality of users compete with each other to achieve the longest spinning time, the greatest spinning speed, or the greatest number of revolutions. Here, too, the device may be programmed to output visual and auditory stimuli to entertain the users, such as emitting a particular light pattern when a new spinning time record is established.

Conclusion

The described embodiments and examples are illustrative only and not intended to be limiting. Although embodiments of the invention can be implemented separately, two or more embodiments of the invention may be integrated into the devices and methods with which they are associated. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be combined in the disclosed configurations.

Various substitutions, modifications, additions and/or rearrangements of the features of embodiments of the invention may be made without deviating from the spirit and/or scope of the underlying inventive concepts. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

What is claimed is:

1. A spinning device, comprising:
(a) a base portion comprising:
a base face; a side face; and a top face;
a substantially ring-shaped groove extending upwardly from the base face, and
a spinning edge portion between the side face and the base face; and
(b) a top portion connected to the top face of the base portion,
the device having a mass distribution balancing the device on the spinning edge portion while the device is spinning.

2. The spinning device of claim 1, where the spinning edge portion is a substantially circular-shaped rim projecting outwardly from the edge where the base face meets the side face.

3. The spinning device of claim 2, where a bottom surface of the rim is flat.

4. The spinning device of claim 1, the height of the device being at least 6 cm to at most 18 cm, and the diameter of the device being at least 6 cm to at most 18 cm.

5. The spinning device of claim 1, where a ratio W_{B}:W_{T} is equal to at least 1:4 to at most 4:1, where W_{B} is the weight of the base portion and W_{T} is the weight of the top portion.

6. The spinning device of claim 1, further comprising one or more of a movable weight and an adjustable weight.

7. The spinning device of claim 1, further comprising a light-emitting element.

8. The spinning device of claim 7, where the light-emitting element is a light emitting diode.

9. The spinning device of claim 1, further comprising one or more of a timer and a spin counter.

10. A method of training motor skills, comprising spinning a spinning device, the spinning device comprising:
(a) a base portion comprising:
a base face; a side face; and a top face;
a substantially ring-shaped groove extending upwardly from the base face, and
a spinning edge portion between the side face and the base face; and
(b) a top portion connected to the top face of the base portion,
the device having a mass distribution balancing the device on the spinning edge portion while the device is spinning.

11. The method of claim 10, where the device is spun with one hand.

12. The method of claim 10, further comprising measuring the spinning time of the device.

13. The method of claim 12, further comprising reporting the spinning time on a display.

14. The method of claim 10, further comprising counting the number of spinning revolutions completed by the device.

15. The method of claim 10, the height of the device being at least 6 cm to at most 18 cm, and the diameter of the device being at least 6 cm to at most 18 cm.

16. The method of claim 10, the device further comprising a light-emitting element.

17. The method of claim 16, where the light-emitting element is a light emitting diode.

18. A spinning device, comprising:
(a) a base portion comprising:
a base face; a side face; and a top face;
a substantially ring-shaped groove extending upwardly from the base face, and
a spinning edge portion between the side face and the base face; and
(b) a top portion connected to the top face of the base portion,
the device having a mass distribution evenly distributed around at least one axis passing through the spinning edge portion and the center of mass of the device.

19. The spinning device of claim 18, where the spinning edge portion is a substantially circular-shaped rim projecting outwardly from the edge where the base face meets the side face.

20. The spinning device of claim 19, where a bottom surface of the rim is flat.
